(19) United States
(12) Patent Application Publication
(10) Pub. No.: US 2003/0224272 A1
(43) Pub. Date: Dec. 4, 2003

(54) Developing agent and image forming apparatus

(75) Inventor: Shuitsu Sato, Tokyo (JP)

Correspondence Address: FOLEY AND LARDNER, SUITE 500, 3000 K STREET NW, WASHINGTON, DC, 20007, US

(73) Assignee: TOSHIBA TEC KABUSHIKI KAISHA

(21) Appl. No.: 10/157,500

(22) Filed: May 30, 2002

(51) Int. Cl. G03G 9/093; G03G 9/09

(52) U.S. Cl. 430/108.1; 430/110.2; 430/108.6; 430/108.4; 430/108.8; 430/137.11; 399/223

(57) ABSTRACT

Disclosed is toner using coloring agent-containing particles including a particulate coloring agent and a particulate additive treated with mechanochemical processing.

### BACKGROUND OF THE INVENTION

The present invention relates to an image forming apparatus using, e.g., an electrostatic recording system and an electrophotographic system and a developing agent used in this apparatus and, more particularly, to a full-color image forming apparatus such as a full-color electrostatic copying machine or full-color laser beam printer and a color developing agent.

Conventionally, an image forming method which forms an image by developing, by using toner, an electrostatic latent image formed on an image carrier such as a photoreceptor, and transferring the obtained toner image onto a transfer medium such as recording paper, has been widely used in copying machines, printers, facsimile apparatuses, and the like.

Recently, a full-color image forming apparatus which reproduces a multicolor image by superposing a plurality of color toners has also put into practical use.

In this full-color image forming apparatus, an organic photoreceptor, for example, is negatively charged by digital writing such as irradiation with an optical beam, and an electrostatic latent image is formed for each dot on this photoreceptor. This electrostatic latent image is subjected to reversal development by using negatively charged magenta toner, cyan toner, yellow toner, and, if necessary, black toner. The obtained toner images are sequentially transferred onto a transfer medium to superpose these toner images of different colors, thereby reproducing a multicolor image.

Full-color image formation described above is mainly used in reproduction of, e.g., pictures, photographs, and graphic images, and a multicolor image is reproduced by superposition of a plurality of color toners as mentioned above. This multicolor image is extensively used not only in image formation onto recording paper but also for an overhead projector transparency, a so-called OHP. However, even if toner has high color reproducibility on recording paper, when an image is formed on an OHP sheet by using the toner and actually projected onto a screen, the color is darkened, and this lowers the color reproducibility.

One cause of this problem is the low dispersibility of the chromatic coloring agent contained in color toner. A chromatic coloring agent such as an organic pigment usually consists of fine primary particles immediately after synthesis. However, secondary aggregation occurs when the primary particles are dried, and this secondary aggregate of about 2 to 10 μm in volume-average particle size is obtained as a final product. When this secondarily aggregated chromatic coloring agent is applied to a conventional kneading/pulverizing method to manufacture color toner, the strong cohesive force of the secondary particles of the chromatic coloring agent does not allow this chromatic coloring agent in color toner to be well finely dispersed.

As a technique for improving the dispersibility of a chromatic coloring agent in toner, Jpn. Pat. Appln. KOKAI Publication No. 62-30259, for example, describes a masterbatch method. In this method, a large amount of a chromatic coloring agent is melted and kneaded into a binder resin beforehand, and the resultant material is pulverized to form a pulverized product (masterbatch). The obtained masterbatch and a binder resin are blended, the blended material is melted and kneaded, and the resultant material is pulverized to obtain color toner.

Even when this masterbatch method is used, however, the dispersibility of the chromatic coloring agent is still unsatisfactory although it improves to some extent. Accordingly, excellent color development properties and high transparency of OHP images cannot be achieved. Also, the number of steps increases when the masterbatch method is used, and this increases the manufacturing cost of color toner.

### BRIEF SUMMARY OF THE INVENTION

The present invention has been made to solve the problems of the aforementioned prior art, and has as its object to provide an inexpensive full-color developing agent having high reproducibility and high transparency.

It is another object of the present invention to provide a full-color image forming apparatus capable of forming an inexpensive image having high color reproducibility and high transparency.

A developing agent of the present invention comprises a binder resin, and coloring agent-containing particles including a particulate coloring agent and a particulate additive treated with mechanochemical processing.

An image forming apparatus of the present invention comprises

at least one image carrier,

a plurality of developing units which oppose the image carrier, contain developing agents having different colors, and form developing agent images of these different colors by developing electrostatic latent images formed in one-to-one correspondence with pieces of image information of the different colors on the image carrier,

a transfer unit which transfers the developing agent images onto a transfer medium, and

a fixing unit which fixes the developing agent images transferred onto the transfer medium,

wherein each of the developing agents comprises a binder resin, and coloring agent-containing particles including a particulate coloring agent and a particulate additive treated with mechanochemical processing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing a model which represents an example of the structure of a coloring agent-containing particle used in the present invention;

FIG. 2 is a view showing a model which represents another example of the structure of the coloring agent-containing particle used in the present invention;

FIG. 3 is a view showing a model which represents still another example of the structure of the coloring agent-containing particle used in the present invention;

FIG. 4 is a view showing the first example of an apparatus for use in mechanochemical processing;

FIG. 5 is a view showing the second example of the apparatus for use in mechanochemical processing;

FIG. 6 is a view showing the third example of the apparatus for use in mechanochemical processing;

FIG. 7 is a view showing the fourth example of the apparatus for use in mechanochemical processing; and

FIG. 8 is a schematic view showing an example of an image forming apparatus of the present invention.

### DETAILED DESCRIPTION OF THE INVENTION

A developing agent of the present invention comprises a binder resin, and coloring agent-containing particles including a particulate coloring agent and a particulate additive treated with mechanochemical processing.

The particulate coloring agent contains at least a dye or a pigment.

The particulate additive also contains at least one additive component.

The coloring agent-containing particles are formed by strongly immobilizing the coloring agent and the additive by mechanochemical processing, and are distinguished from those immobilized by processing other than the mechanochemical processing.

Examples of the mechanochemical processing used in the present invention are processing using mechanical impactive force and dry mechanochemical processing. In the mechanical impact processing, child particles can be immobilized on the surfaces of mother particles and formed into particles in a high-speed air flow by the shearing force of a rotor and stator and on impact of collision between the particles and with the machine wall. In the dry mechanochemical method, child particles can be immobilized on the surfaces of mother particles and formed into particles by using heat generated by friction, compression, and shearing force between the material particles and between these particles and wall members of an apparatus.

As processing other than the mechanochemical processing, it is possible to simply mix and pulverize a coloring agent, additive, and adhesive. In this processing, the coloring agent and the additive are immobilized by the adhesive action. Unfortunately, this processing is expensive because a plurality of steps such as mixing and pulverization are presumably necessary. Also, in the coloring agent-containing particles used in the present invention, the coloring agent and the additive are immobilized by the mechanochemical processing more strongly than when they are immobilized only with the adhesive action.

In the present invention, coloring agent-containing particles immobilized by the mechanochemical processing are used. This makes it possible to improve the dispersibility of the binder resin and the coloring agent in the toner particles, and improve the transparency of an obtained image. Therefore, regardless of whether an image is formed on a recording sheet or OHP sheet, a color image having superior color development properties and high transparency can be obtained.

Also, in the present invention, coloring agent-containing particles immobilized by the mechanochemical processing beforehand are formed. Hence, variations in the material characteristics are reduced compared to processing in which a pigment, dye, and the like are used singly. This eliminates the cumbersome operation of changing the pigment, dye, and manufacturing conditions used, and facilitates handling of coloring agent components during manufacture. Consequently, the operation efficiency can be improved.

Furthermore, in the present invention, effects equal to or superior to those obtained by the masterbatch method which is conventionally used to improve the color development properties and transparency can be obtained without using this masterbatch method. Since this eliminates the cost required for the masterbatch, an inexpensive developing agent can be obtained.

Three structures explained below are examples of the structure of the coloring agent-containing particle obtained by subjecting the particulate coloring agent and the particulate additive to the mechanochemical processing. One of these structures to be used can be selected in accordance with the sizes of the coloring agent and additive, the hardness during the mechanochemical processing, and the like.

FIGS. 1 to 3 are views showing models which represent the structures of the coloring agent-containing particles used in the present invention.

As shown in FIG. 1, in the first structure an additive covering layer 2 is formed on the surface of a coloring agent core 1 by the mechanochemical processing.

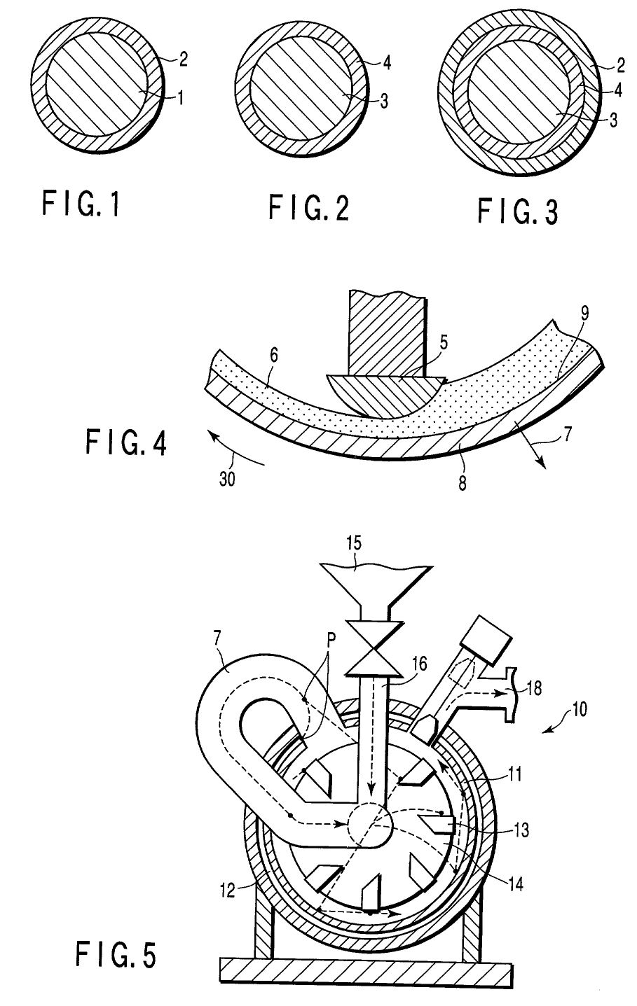

As shown in FIG. 2, in the second structure a coloring agent covering layer 4 is formed on the surface of an additive core 3 by the mechanochemical processing.

As shown in FIG. 3, in the third structure a coloring agent covering layer 4 and a second additive covering layer 2 are formed in this order on a first additive core 3 by the mechanochemical processing.

In the first structure, a metal oxide, for example, can be used as the covering additive.

In the second and third structures, it is possible to use as the additive core or as the first additive core at least one material selected from the group consisting of fine crystalline polyester particles, wax particles, and metallic soap particles.

In the third structure, a metal oxide, for example, can be used as the second additive.

Practical examples are the following seven coloring agent-containing particles.

(1) A coloring agent-containing particle which has the first structure and in which a metal oxide covering layer is formed on a coloring agent core by the mechanochemical processing.

(2) A coloring agent-containing particle which has the second structure and in which a coloring agent covering layer is formed on a fine crystalline polyester particle core by the mechanochemical processing.

(3) A coloring agent-containing particle which has the second structure and in which a coloring agent covering layer is formed on a wax particle core by the mechanochemical processing.

(4) A coloring agent-containing particle which has the second structure and in which a coloring agent covering layer is formed on a metallic soap particle core by the mechanochemical processing.

(5) A coloring agent-containing particle which has the third structure and in which a coloring agent covering layer and a metal oxide covering layer are formed in this order on a fine crystalline polyester particle core by the mechanochemical processing.

(6) A coloring agent-containing particle which has the third structure and in which a coloring agent covering layer and a metal oxide covering layer are formed in this order on a wax particle core by the mechanochemical processing.

(7) A coloring agent-containing particle which has the third structure and in which a coloring agent covering layer and a metal oxide covering layer are formed in this order on a metallic soap particle core by the mechanochemical processing.

Ten to 100 parts by weight of the metal oxide particles are preferably used with respect to 100 parts by weight of the coloring agent particles or of the additive particles each having the coloring agent covering layer. If this amount is less than 10 parts by weight, the surface covering ratio is insufficient, so dispersion often becomes unsatisfactory when the particles are kneaded into a binder resin. If the amount exceeds 100 parts by weight, the surface covering is excessive, and this excessive amount causes poor dispersion. Consequently, dispersion often becomes unsatisfactory as a whole.

Ten to 50 parts by weight of the coloring agent particles are preferably used with respect to 100 parts by weight of the crystalline polyester compound particles. If this amount is less than 10 parts by weight, the surface covering ratio is insufficient, so dispersion often becomes unsatisfactory when the particles are kneaded into a binder resin. If the amount exceeds 50 parts by weight, the surface covering is excessive, and this excessive amount causes poor dispersion. Consequently, dispersion often becomes unsatisfactory as a whole.

One hundred to 200 parts by weight of the coloring agent particles are preferably used with respect to 100 parts by weight of the wax particles. If this amount is less than 100 parts by weight, the surface covering ratio is insufficient, so dispersion often becomes unsatisfactory when the particles are kneaded into a binder resin. If the amount exceeds 200 parts by weight, the surface covering is excessive, and this excessive amount causes poor dispersion. Consequently, dispersion often becomes unsatisfactory as a whole.

One hundred to 200 parts by weight of the coloring agent particles are preferably used with respect to 100 parts by weight of the metallic soap particles. If this amount is less than 100 parts by weight, the surface covering ratio is insufficient, so dispersion often becomes unsatisfactory when the particles are kneaded into a binder resin. If the amount exceeds 200 parts by weight, the surface covering is excessive, and this excessive amount causes poor dispersion. Consequently, dispersion often becomes unsatisfactory as a whole.

Also, the coloring agent-containing particles have an average particle size of preferably 25 to 1,250 nm, and more preferably, 100 to 500 nm.

The crystalline polyester compound particle used in the present invention contains an acid component and an alcohol component. Examples of the acid component are aromatic polycarboxylic acid such as terephthalic acid, isophthalic acid, phthalic acid, naphthalenedicarboxylic acid, trimellitic acid, pyromellitic acid, and benzophenonetetracarboxylic acid; aromatic oxycarboxylic acid such as p-(2-hydroxyethoxy)benzoic acid; and aliphatic polycarboxylic acid such as succinic acid, fumaric acid, adipic acid, azelaic acid, sebacic acid, and decanemethylenedicarboxylic acid. Examples of the alcohol component are aliphatic polyol such as ethyleneglycol, propyleneglycol, 1,4-butanediol, 1,3-butanediol, 1,5-pentanediol, 1,6-hexanediol, neopentyneglycol, glycerin, trimethylolethane, trimethylolpropane, and pentaerythtol; alicyclic polyol such as 1,4-cyclohexanediol and 1,4-cyclohexanedimethanol; and an ethylene oxide or propylene oxide adduct such as bisphenol A. The crystalline polyester compound particle is particularly a normally wax-like crystalline compound which has an alkyl or alkenyl group having 16 or more carbon atoms and which is obtained by condensation polymerization of an alcohol component containing 80 mol % or more of diol having 2 to 6 carbon atoms and a carboxylic acid component containing 80 mol % or more of fumaric acid. This compound preferably has a melting point of 50 to 150° C. It is possible to use one type of these compounds or to mix two or more types of them. The crystalline polyester particles have an average particle size of preferably 500 to 5,000 nm, and more preferably, 1,000 to 4,000 nm.

As the metal oxide usable in the present invention, it is possible to use fine colorless or white particles having no influence on the color reproduction of color toner. Examples of this metal oxide are silicon oxide, titanium dioxide, aluminum oxide, tin oxide, zinc oxide, and calcium oxide. The BET specific surface area of the fine metal oxide particles is preferably 20 to 300 m²/g, and more preferably, 30 to 250 m²/g. From the viewpoint of the environmental stability of toner, it is favorable to use fine hydrophobic metal oxide particles surface-treated by a hydrophobicity imparting agent. It is possible to use one type of these fine metal oxide particles or to mix two or more types of them. The metal oxide particles preferably have an average particle size of preferably 5 to 1,000 nm, and more preferably, 10 to 250 nm.

Examples of the wax used in the present invention are a polyolefin resin, fatty acid metal salt, fatty ester, fatty amide, alkylene bisfatty amide, ester of polyhydric alcohol, higher fatty acid, higher alcohol, paraffin wax, hydrocarbon wax, Fischer-Tropsch wax, carnauba wax, montan wax, and rice wax. These waxes can be used singly or in the form of a mixture of two or more types of them. The wax particles have an average particle size of preferably 500 to 5,000 nm, and more preferably, 1,000 to 4,000 nm.

The metallic soap used in the present invention consists of a simple fatty acid, a saturated or unsaturated fatty acid having four or more carbon atoms, an alkali earth metal, and another metal. Examples of the simple fatty acid are caprylic acid, capric acid, lauric acid, myristic acid, myristoleic acid, palmitic acid, isopalmitic acid, palmitoleic acid, stearic acid, behenic acid, lignoceric acid, cerotic acid, montanic acid, isostearic acid, oleic acid, arachic acid, ricinoleic acid, linoleic acid, and erucic acid. Representative examples of the saturated or unsaturated fatty acid having four or more carbon atoms are those derived from animal and vegetable oils such as beef tallow fatty acid, soybean oil fatty acid, coconut oil fatty acid, and palm oil fatty acid. Examples of the alkali earth metal are calcium, barium, and magnesium. Examples of the other metal are titanium, zinc, copper, manganese, cadmium, mercury, zirconium, lead, iron, aluminum, cobalt, nickel, and silver. Ca salt, Zn salt, or Ba salt of saturated or unsaturated fatty acid having 10 to 24 carbon atoms, preferably, 12 to 22 carbon atoms, is particularly favored. In particular, Ca salt, Zn salt, or Ba salt of saturated or unsaturated fatty acid having 14 to 22 carbon atoms is preferred. These metallic soaps can be used singly or in the form of a mixture of two or more types of them. The metallic soap particles have an average particle size of preferably 500 to 5,000 nm, and more preferably, 1,000 to 4,000 nm.

As the binder resin usable in the present invention, it is preferable to use a resin having specific melting characteristics for obtaining high transparency and high color reproducibility as full-color toner. Also, the use of a binder resin having a softening point of 90 to 115° C. is favored from the viewpoint of immobilizing properties. The type of binder resin is not restricted as long as the resin has the above-mentioned properties. For example, it is possible to use a styrene-acryl copolymerized resin, polyester-based resin, and epoxy-based resin singly or in the form of a mixture. Of these resins, a polyester resin is particularly preferred.

This polyester resin favorable as the binder resin is synthesized by polycondensation of a bisphenol A alkylene oxide adduct as an alcohol component and phthalic acid-based dicarboxylic acid or phthalic acid-based dicarboxylic acid and aliphatic dicarboxylic acid as acid components. These polyester resins can be used singly or in the form of a blend of two or more types of them as needed.

As a charge control agent usable in the present invention, it is preferable to use a colorless, white, or light-colored material having no influence on the color reproduction of color toner. Examples of this charge control agent are chromium salicylate complex salts E-81 and E-82 (manufactured by Orient Chemical Industries, Ltd.), zinc salicylate complex salt E-84 (manufactured by Orient Chemical Industries, Ltd.), aluminum salicylate complex salt E-86 (manufactured by Orient Chemical Industries, Ltd.), calix arene-based compound E-89 (manufactured by Orient Chemical Industries, Ltd.), and boron benzilate complex salt.

If necessary, it is also possible to add waxes such as low-molecular-weight polypropylene wax, low-molecular-weight polyethylene wax, carnauba wax, and sasol wax. These waxes can be added to improve the offset resistance, and to prevent adhesion of toner to the regulating blade and to the developing roller of a developing apparatus when the toner is nonmagnetic mono-component toner.

In the present invention, to improve the fluidity and chargeability, fine inorganic particles having an average particle size of, e.g., 10 to 40 nm can be added as a fluidizing agent to the surface of a toner particle in an amount of 0.2 to 3 wt % with respect to the toner particle weight. As this fine inorganic particle, it is possible to use silica, titania, alumina, strontium titanate, and tin oxide singly or in the form of a mixture of two or more types of them. To improve the environmental stability, it is favorable to use fine inorganic particles surface-treated by a hydrophobicity imparting agent. Also, to improve the cleaning properties, fine resin particles of 1 μm or less can be added to the toner particle surface in addition to the inorganic oxide.

A known coloring agent can be used as the coloring agent usable in the present invention. Examples are magenta coloring agents such as C.I. Pigment Reds 1 to 19, 21 to 23, 30 to 32, 37 to 41, 48 to 55, 57, 60, 63, 64, 68, 81, 83, 87 to 90, 112, 114, 122, 123, 163, 184, 202, 206, 207, and 209; yellow coloring agents such as C.I. Pigment Yellows 1 to 7, 10 to 17, 23, 65, 73, 74, 83, and 180 and C.I. Vat Yellows 1, 3, and 20; and cyan coloring agents such as C.I. Pigment Blues 2, 3, and 15 to 17.

Examples of the mechanochemical processing used in the present invention are processing using mechanical shock and dry mechanochemical processing.

Examples of a mechanism for use in the mechanical shock processing are an NHS-1 hybridizer (manufactured by Nara Machinery Co., Ltd.) and a cosmos system (manufactured by Kawasaki Heavy Industries, Ltd.) Examples of a mechanism for use in the dry mechanochemical processing are a mechanofusion apparatus (manufactured by HOSOKAWA MICRON CORP.) and a mechano-mill (manufactured by Okada Seiko).

FIG. 4 is a conceptual view for explaining the principle of mechanofusion.

In mechanofusion, an ordered mixture formed by sticking child particles to mother particles by dry-mixing the mother particles and a powder material containing the child particles is placed, as a powder material 6, in a rotary vessel 8 which rotates in the direction of an arrow 30. This powder material 6 is immobilized against the vessel inner wall 9 by the centrifugal force in the direction of an arrow 7. In addition, an inner piece 5 having a radius of curvature different from that of the inner wall 9 is applied to the immobilized powder material 6 to give it stronger compression and shearing force. In this manner, it is possible to form composite particles, control the particle shape, and perform precision mixing.

FIG. 5 is a schematic view showing an example of an apparatus for use in hybridization.

In this hybridization, an apparatus 10 as shown in FIG. 5 is used. This apparatus 10 has a cylindrical stator 11, a rotor 14 installed in the stator 11, a charge port 15, a supply path 16 connected to the charge port 15, a circulating path 17, and a discharge port 18. The stator 11 has a water-cooling and heating jacket 12. The rotor 14 has a plurality of blades 13 and can rotate at high speed. The charge port 15 charges a powder material into the stator 11. The supply path 16 conveys the powder material to the center of the rotor 14. The circulating path 17 conveys the powder material again from the stator inner wall to the center of the rotor 14. The discharge port 18 discharges the processed powder material.

In this apparatus as shown in FIG. 5, an ordered mixture, for example, is charged as a powder material from the charge port 15 and dispersed onto the inner walls of the rapidly rotating rotor 14 and the stator 11. This powder material is circulated again from the stator inner wall to the center of the rotor 11 and thereby repeatedly given primarily impact force and mechanical actions, such as compression, friction, and shearing force, including interaction between particles. In this manner, it is possible to immobilize mother particles by child particles, form films, and round the particles. The processed powder material can be immediately collected by a collector (not shown) through the discharge port 18. In FIG. 5, reference symbol P denotes a powder material, and arrows indicated by the dotted lines represent the behavior of this powder material P.

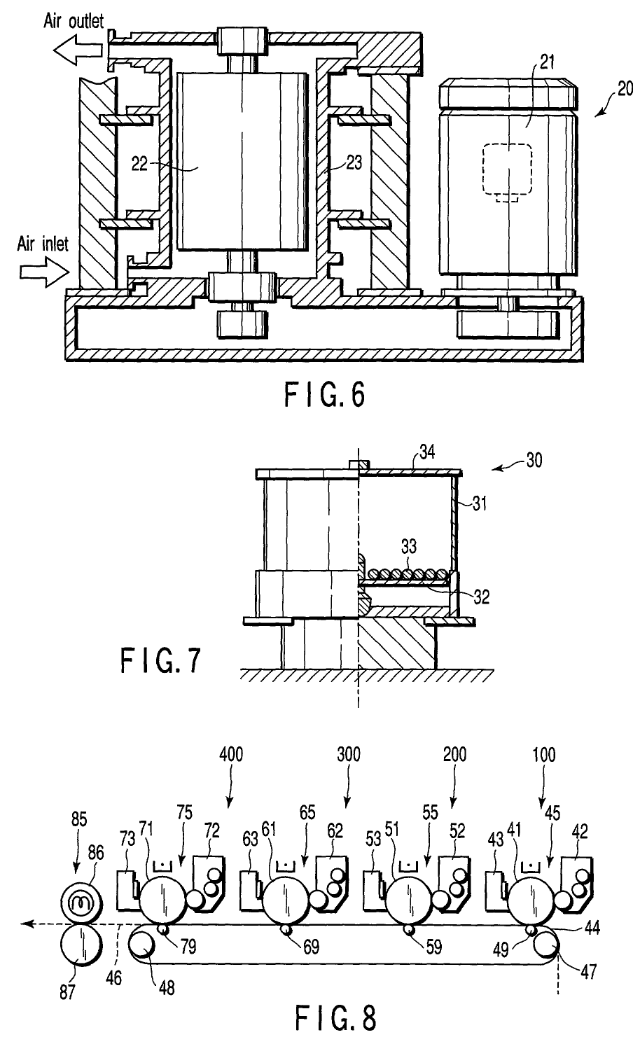

FIG. 6 is a schematic view showing an example of an apparatus used in the cosmos system.

As shown in FIG. 6, this apparatus 20 has a motor 21, a rotor 22, and a stator 23. The rotor 22 can rotate at high speed when driven by the motor 21 by using a V belt, and has a blade (not shown). The stator 23 has an air inlet and an air outlet. A liner blade (not shown) having a large number of grooves is attached to this stator 23.

In this apparatus 20, material particles drawn by suction together with air from the air inlet are evenly dispersed on the circumference by the rapidly rotating rotor 22. Then, the material particles repeat intense impact and contact due to numberless eddy currents generated between the rotor blade and liner blade having special shapes. After mother particles are immobilized by child particles and films are formed, the material particles are exhausted to the outside from the air outlet.

FIG. 7 is a view showing an outline of an apparatus for use in the mechano-mill.

As shown in FIG. 7, this apparatus 30 has a cylindrical bath 31, a rotary plate 32 placed in this cylindrical bath 31, a plurality of balls 33 arranged on the rotary plate 32, and an upper lid 34 attached to the upper portion of the cylindrical bath 31.

In this apparatus 30, the rotary plate 32 placed in the cylindrical bath 31 rapidly rotates together with the balls to disperse and cause to collide material particles, thereby immobilizing mother particles by child particles and forming films.

The developing agent according to the present invention can be used as a nonmagnetic two-component developing agent in which a carrier and a nonmagnetic toner are mixed, and as a nonmagnetic mono-component developing agent using no carrier.

The present invention also provides an image forming apparatus using the developing agent described above.

This image forming apparatus comprises

at least one image carrier,

a plurality of developing units which oppose the image carrier, contain developing agents having different colors, and form developing agent images of these different colors by developing electrostatic latent images formed in one-to-one correspondence with pieces of image information of the different colors on the image carrier,

a transfer unit which transfers the developing agent images onto a transfer medium, and

a fixing unit which fixes the developing agent images transferred onto the transfer medium,

wherein each of the developing agents used contains coloring agent-containing particles including a particulate coloring agent and a particulate additive treated with mechanochemical processing, and a binder resin.

FIG. 8 is a view showing an outline of an example of a full-color image forming apparatus according to the present invention.

Referring to FIG. 8, a photoreceptor drum 41 as an image carrier is a cylindrical laminated organic photoreceptor which can rotate in the direction of an arrow. Around this photoreceptor drum 41, the following units are arranged in the direction of rotation. That is, an exposure unit 45 forms an electrostatic latent image by exposing to light the surface of the photoreceptor drum 41 charged by a charge roller (not shown). On the downstream side of this exposure unit 45, a nonmagnetic two-component developing unit 42 containing a developing agent develops the electrostatic latent image formed by the exposure unit 45 by applying a predetermined developing bias voltage to the developing agent via a developing bias voltage generation circuit (not shown). On the downstream side of the developing unit 42, a conveyor means 44 conveys a paper sheet as a transfer medium to the photoreceptor drum 41.

In addition, a blade cleaning unit 43 and a charge removal lamp (not shown) are arranged downstream of the position where the photoreceptor drum 41 contacts the paper sheet.

The conveyor means 44 has a width substantially equal to the drum width of the photoreceptor drum 41. This conveyor means 44 takes the form of an annular belt. A tension roller 47 and a driving roller 48 are positioned in the upstream and downstream round portions of the conveyor means 44. In these round portions, the conveyor means 44 contacts the tension roller 47 and the driving roller 48 along the circumferential surfaces of the tension roller 47 and the driving roller 48.

An annular belt as the conveyor means 44 is a commonly known film such as a polyamide or modified polyamide film having a thickness of 85 to 150 μm and a volume resistivity of 10⁹ to 10¹¹ Ω·cm. Since the film has this volume resistivity, a low-resistance substance can be applied or adhered to the surface of the film or doped into the film. The tension roller 47 and the driving roller 48 can rotate in the direction of an arrow shown in FIG. 8. With this rotation of the driving roller 48, the conveyor means 44 is fed in the form of an annular belt. The conveying speed is so controlled as to synchronize with the rotating speed of the photoreceptor.

The photoreceptor drum 41, the exposure unit 45, the developing unit 42, and the blade cleaning unit 43 described above and the charge removal lamp (not shown) construct a process unit 100.

On the conveyor means 44, this process unit 100 and other process units 200, 300, and 400 are arranged along the conveyance direction between the tension roller 47 and the driving roller 48. Each of these process units 200, 300, and 400 has the same configuration as the process unit 100.

That is, photoreceptor drums 51, 61, and 71 are positioned in substantially the centers of the corresponding process units. Around these photoreceptor drums, exposure units 55, 65, and 75; developing units 52, 62, and 72 positioned downstream of the exposure units 55, 65, and 75; and blade cleaning units 53, 63, and 73 are arranged, similar to the process unit 100.

A difference between these process units is a developing agent contained in the developing unit. For example, the developing units 42, 52, 62, and 72 contain yellow, magenta, cyan, and black developing agents, respectively.

To output a color image, a paper sheet conveyed by the conveyor means 44 comes into contact with the photoreceptor drums 41, 51, 61, and 71 in this order. In the positions where this paper sheet contacts the photoreceptor drums 41, 51, 61, and 71, power supply rollers 49, 59, 69, and 79 as transfer means are placed in one-to-one correspondence with the photoreceptor drums 41, 51, 61, and 71, respectively.

That is, the power supply rollers 49, 59, 69, and 79 are in contact with the back surface of the conveyor means 44 in the positions where these rollers contact the corresponding photoreceptor drum 41, and oppose the photoreceptor drum 41 via the conveyor means 44. Note that the power supply rollers 49, 59, 69, and 79 are connected to bias power supplies (not shown). These power supply rollers 149, 59, 69, and 79 rotate along with the movement of the conveyor means 44.

An image formation process of the full-color electrophotographic apparatus constructed as above will be explained below. The photoreceptor drums 41, 51, 61, and 71 of the four process units described above are uniformly charged to a preset potential by charging means (not shown) to which an AC-superposed DC bias is applied.

These uniformly charged photoreceptor drums 41, 51, 61, and 71 are irradiated with light by the exposure units 45, 55, 65, and 75, respectively, which perform exposure by using phosphors, thereby forming electrostatic latent images. The developing units 42, 52, 62, and 72 develop these electrostatic latent images by using, e.g., nonmagnetic two-component developing agents of different colors which are well charged in advance.

A paper sheet is fed from a paper feed cassette (not shown) to the transfer position of the photoreceptor drum 41.

When this paper sheet is conveyed to the transfer position, the power supply rollers 49, 59, 69, and 79 apply a voltage of, e.g., 800 to 3,000 V as a bias voltage to the conveyor means 14. This application of the bias voltage forms transfer electric fields between the photoreceptor drums 41, 51, 61, and 71 and the conveyor means 14. Accordingly, the developing agent image on the photoreceptor drum 11 is first transferred onto the paper sheet. This paper sheet onto which the developing agent image is transferred is conveyed to the photoreceptor drum 51. The developing agent image formed on this photoreceptor drum 51 is transferred and superposed on the previously transferred developing agent image. The paper sheet onto which these developing agent images are transferred is further conveyed, and the developing agent images of the respective corresponding colors on the photoreceptor drums 61 and 71 are similarly transferred.

The paper sheet carrying the images thus formed by multiple transfer is conveyed to a fixing unit 85 from the conveyor means 44. This fixing unit 85 has a heat roller 86 and a pressure roller 87. The fixing unit 85 fixes the images formed by multiple transfer to the paper sheet.

The heat roller 86 is obtained by coating silicone rubber with a fluorine-containing resin. The hardness of the silicone rubber is preferably 10 to 40 degrees. The thickness of the coating agent is 10 to 50 μm, and a perfluoroalkoxyalkane resin (PFA) or polytetrafluoroethylene (PTFE) is preferably used. The silicone rubber can also contain a plasticizer in order to control the hardness.

The pressure roller 85 is made of silicone rubber having a hardness of 20 to 60 degrees. This hardness must be lower than that of the heat roller. If this pressure roller 85 is hard, a paper sheet may wind around the pressure roller to cause a paper jam.

Also, a roller impregnated with oil can be used as one or both of the heat roller and the pressure roller to remove extraneous matter sticking to these rollers and prevent easy adhesion of extraneous matter.

Although FIG. 8 shows an example of a nonmagnetic two-component image forming apparatus, a nonmagnetic mono-component image forming apparatus can also be used.

Also, FIG. 8 shows as an example of the arrangement in which four developing units each including one photoreceptor and one developing unit opposing the photoreceptor are arrayed. However, the number of photoreceptors used and the number of developing units opposing one photoreceptor are not limited to these numbers.

The developing agent according to the present invention can be manufactured by the following method.

i) Formation of Coloring Agent-Containing Particles

100 parts by weight of coloring agent particles and 10 to 100 parts by weight of additive particles are subjected to mechanochemical processing to obtain coloring agent-containing particles.

ii) Formation of Toner Particles

A binder resin, coloring agent-containing particles, and additives such as a release agent and charge control agent in appropriate blending amounts are put into, e.g., a Henschel mixer “FM” (Mitsui Miike Kakoki K.K.) and uniformly mixed to obtain a mixture of toner particle materials.

Examples of the blending amounts are 2 to 10 parts by weight, preferably, 3 to 8 parts by weight of the coloring agent, 0.5 to 10 parts by weight, preferably, 2 to 8 parts by weight of the release agent, and 5 parts by weight or less, preferably, 3 parts by weight of the charge control agent, with respect to 100 parts by weight of the binder resin. In addition, appropriate amounts of additives such as a dispersant can be added.

The obtained mixture is melted and kneaded by using, e.g., a biaxial kneader/extruder (PCM, manufactured by Ikegai Kasei K.K.). In this way, the coloring agent-containing particles and the various additives are dispersed in the binder resin to obtain a kneaded product.

Other examples of the melting/kneading means are continuous kneaders such as “TEM” (Toshiba Machine Co., Ltd.) and a “KRC kneader” (KURIMOTO, LTD.), and batch kneaders such as a heating kneader and a pressure kneader.

The obtained kneaded product is coarsely pulverized. After that, this coarsely pulverized product is finely pulverized by collision pulverization by jet air by using, e.g., a jet pulverizer “AFG” (Hosokawa Micron Corp.) or “IDS” (Nippon Pneumatic Mfg. Co., Ltd.), thereby obtaining a pulverized product having an average particle size of 7 to 10 μm.

Other examples of the pulverizing means are a Turbo-Mill mechanical pulverizer (Kawasaki Heavy Industries, Ltd.) and Super Rotor (Nisshin Engineering Inc.)

The obtained pulverized product is classified to remove fine powders, thereby obtaining toner particles. In this classification step, to sharpen the particle size distribution, particle size adjustment by air or by rotation of a rotor is performed using an air classifier “ATP” (Hosokawa Micron Corp.), “DSX” (Nippon Pneumatic Mfg. Co., Ltd.), or “Elbow-Jet” (Nittetsu Mining Co., Ltd.)

iii) Manufacturing of Toner

The obtained toner particles and a suitable amount of a fluidizing agent are put into, e.g., the Henschel mixer “FM” (Mitsui Miike Kakoki K.K.) and uniformly mixed to obtain toner. After the mixing, mixed coarse particles can be sifted out by a sieve having a predetermined appropriate mesh.

The present invention will be described in more detail below by way of its examples.

### EXAMPLES

First, a plurality of types of coloring agent-containing particles were formed as follows as examples of the use of an NHS hybridization system as mechanochemical processing.

Coloring Agent-Containing Particle 1

100 parts by weight of C.I. Pigment Yellow 180 having an average particle size of 150 nm and 50 parts by weight of hydrophobic silica (R972, manufactured by Nippon Aerosil Co., Ltd.) having an average particle size of 16 nm were rotated at a medium speed for 3 minutes and then at a high speed for 3 minutes in the NHS hybridization system (Nara Machinery Co., Ltd.), thereby obtaining coloring agent-containing particles 1 having an average particle size of 180 nm.

The section of the obtained coloring agent-containing particle was observed with a transmission electron microscope (TEM), and found to have the first structure.

Note that in this NHS, a medium speed means the range within which the outer peripheral speed of an impact pin is 30 to 80 m/sec, and a high speed means the range within which it is 80 to 150 m/sec.

Coloring Agent-Containing Particle 2

100 parts by weight of C.I. Pigment Yellow 180 having an average particle size of 150 nm and 600 parts by weight of crystalline polyester compound particles containing fumaric acid as an acid component and 1,4-butanediol as an alcohol component, and finely pulverized by refrigerating pulverization to have an average particle size of 3,000 nm were rotated at a medium speed for 3 minutes and then at a high speed for 3 minutes in the NHS hybridization system (Nara Machinery Co., Ltd.), thereby obtaining coloring agent-containing particles 2 having an average particle size of 3,300 nm.

The section of the obtained coloring agent-containing particle was observed with a transmission electron microscope (TEM), and found to have the second structure.

Coloring Agent-Containing Particle 3

100 parts by weight of C.I. Pigment Yellow 180 having an average particle size of 150 nm and 65 parts by weight of rice wax particles finely pulverized by refrigerating pulverization to have an average particle size of 3,000 nm were rotated at a medium speed for 3 minutes and then at a high speed for 3 minutes in the NHS hybridization system (Nara Machinery Co., Ltd.), thereby obtaining coloring agent-containing particles 3 having an average particle size of 3,300 nm.

The section of the obtained coloring agent-containing particle was observed with a transmission electron microscope (TEM), and found to have the second structure.

Coloring Agent-Containing Particle 4

100 parts by weight of coloring agent-containing particles 2 and 50 parts by weight of hydrophobic silica (R972, manufactured by Nippon Aerosil Co., Ltd.) having an average particle size of 16 nm were rotated at a medium speed for 3 minutes and then at a high speed for 3 minutes in the NHS hybridization system (Nara Machinery Co., Ltd.), thereby obtaining coloring agent-containing particles 4 having an average particle size of 3,500 nm.

The section of the obtained coloring agent-containing particle was observed with a transmission electron microscope (TEM), and found to have the third structure.

Coloring Agent-Containing Particle 5

100 parts by weight of coloring agent-containing particles 3 and 50 parts by weight of hydrophobic silica (R972, manufactured by Nippon Aerosil Co., Ltd.) having an average particle size of 16 nm were rotated at a medium speed for 3 minutes and then at a high speed for 3 minutes in the NHS hybridization system (Nara Machinery Co., Ltd.), thereby obtaining coloring agent-containing particles 5 having an average particle size of 3,500 nm.

The section of the obtained coloring agent-containing particle was observed with a transmission electron microscope (TEM), and found to have the third structure.

Coloring Agent-Containing Particle 6

100 parts by weight of C.I. Pigment Yellow 180 having an average particle size of 150 nm and 65 parts by weight of zinc stearate particles finely pulverized by refrigerating pulverization to have an average particle size of 3,000 nm were rotated at a medium speed for 3 minutes and then at a high speed for 3 minutes in the NHS hybridization system (Nara Machinery Co., Ltd.), thereby obtaining coloring agent-containing particles 6 having an average particle size of 3,300 nm.

The section of the obtained coloring agent-containing particle was observed with a transmission electron microscope (TEM), and found to have the second structure.

Coloring Agent-Containing Particle 7

100 parts by weight of coloring agent-containing particles 6 and 50 parts by weight of hydrophobic silica (R972, manufactured by Nippon Aerosil Co., Ltd.) having an average particle size of 16 nm were rotated at a medium speed for 3 minutes and then at a high speed for 3 minutes in the NHS hybridization system (Nara Machinery Co., Ltd.), thereby obtaining coloring agent-containing particles 7 having an average particle size of 3,500 nm.

Coloring Agent-Containing Particle 8

100 parts by weight of coloring agent-containing particles 6 and 50 parts by weight of titanium oxide (NKT-90, manufactured by Nippon Aerosil Co., Ltd.) having an average particle size of 40 nm were rotated at a medium speed for 3 minutes and then at a high speed for 3 minutes in the NHS hybridization system (Nara Machinery Co., Ltd.), thereby obtaining coloring agent-containing particles having an average particle size of 3,500 nm.

### Example 1

7 parts by weight of coloring agent-containing particles 1, 100 parts by weight of a polyester binder resin, 1 part by weight of a negative charge control agent, and 2 parts by weight of rice wax were put into a Henschel mixer (manufactured by Mitsui Miike Kakoki) and mixed at a peripheral speed of 20 m/sec for 5 minutes, thereby obtaining a mixture.

Note that the polyester resin was formed by mixing, at a weight ratio of 1:1, a polyester resin obtained from a bisphenol A propylene oxide adduct/bisphenol A ethylene oxide adduct/terephthalic acid, and a polyester resin obtained from a bisphenol A propylene oxide adduct/fumaric acid. This polyester resin had a softening point of 98° C., a glass transition point of 62° C., and a volume-average particle size of 0.8 mm.

The obtained mixture was kneaded by a PCM (trade name) biaxial extruding kneader manufactured by Ikegai Tekko. The cooled kneaded product was coarsely pulverized by a feather mill, finely pulverized by a jet mill, and finely classified by an air classifier to obtain yellow toner particles having a volume-average particle size of 8 μm.

100 parts by weight of the obtained toner particles and 1 part by weight of hydrophobic silica were put into the Henschel mixer and mixed at a peripheral speed of 20 m/sec for 3 minutes to obtain nonmagnetic yellow toner.

Ferrite coated with a silicone resin and having an average particle size of about 50 μm was prepared as a carrier. Eight parts by weight of the obtained yellow toner were added to 100 parts by weight of the carrier, and the resultant material was mixed for 30 minutes by a V blender, thereby obtaining a nonmagnetic two-component yellow developing agent.

The yellow developing agent obtained as above was used to form an image on an OHP sheet by using a PREMAGE 251 (trade name) copying machine manufactured by TOSHIBA CORP.

The color development properties and transparency of the formed image were tested and evaluated as follows.

Color Development Property Test

The fixed image on the OHP sheet was projected onto a screen by transmitting and reflecting OHPs, and the color images on the screen were visually observed to evaluate the color reproducibility. ⊚ indicates that the color reproducibility was excellent; ∘, the color reproducibility was satisfactory; Δ, the color reproducibility was slightly inferior, but color discrimination was possible; and X, color discrimination was impossible.

Transparency Test

The haze value of the fixed image on the OHP sheet was measured using a MODEL NDH-1001DP haze meter manufactured by Nippon Denshoku Industries Co., Ltd.

⊚ indicates that the haze value was less than 30; ∘, the haze value was 30 to less than 40; Δ, the haze value was 40 to less than 50; and X, the haze value was 50 or more. Note that the smaller the haze value, the higher the transparency.

The obtained results are shown in Table 1.

### Example 2

A yellow developing agent was obtained following the same procedures as in Example 1, except that 30 parts by weight of coloring agent-containing particles 2 were used instead of coloring agent-containing particles 1.

The obtained developing agent was tested and evaluated in the same manner as in Example 1. The results are shown in Table 1.

### Example 3

A yellow developing agent was obtained following the same procedures as in Example 1, except that 8 parts by weight of coloring agent-containing particles 3 were used instead of coloring agent-containing particles 1.

The obtained developing agent was tested and evaluated in the same manner as in Example 1. The results are shown in Table 1.

### Example 4

A yellow developing agent was obtained following the same procedures as in Example 1, except that 35 parts by weight of coloring agent-containing particles 4 were used instead of coloring agent-containing particles 1.

The obtained developing agent was tested and evaluated in the same manner as in Example 1. The results are shown in Table 1.

### Example 5

A yellow developing agent was obtained following the same procedures as in Example 1, except that 10 parts by weight of coloring agent-containing particles 5 were used instead of coloring agent-containing particles 1.

The obtained developing agent was tested and evaluated in the same manner as in Example 1. The results are shown in Table 1.

### Example 6

A yellow developing agent was obtained following the same procedures as in Example 1, except that 8 parts by weight of coloring agent-containing particles 6 were used instead of coloring agent-containing particles 1.

The obtained developing agent was tested and evaluated in the same manner as in Example 1. The results are shown in Table 1.

### Example 7

A yellow developing agent was obtained following the same procedures as in Example 1, except that 10 parts by weight of coloring agent-containing particles 7 were used instead of coloring agent-containing particles 1.

The obtained developing agent was tested and evaluated in the same manner as in Example 1. The results are shown in Table 1.

### Example 8

A yellow developing agent was obtained following the same procedures as in Example 1, except that 10 parts by weight of coloring agent-containing particles 8 were used instead of coloring agent-containing particles 1.

The obtained developing agent was tested and evaluated in the same manner as in Example 1. The results are shown in Table 1.

### Comparative Example 1

A yellow developing agent was obtained following the same procedures as in Example 1, except that 16 parts by weight of a masterbatch obtained by melting and kneading a polyester resin and C.I. Pigment Yellow 180 at a weight ratio of 6:4 by using a three-roll mill were used instead of coloring agent-containing particles 1.

The obtained developing agent was tested and evaluated in the same manner as in Example 1. The results are shown in Table 1.

### Comparative Example 2

A yellow developing agent was obtained following the same procedures as in Example 1, except that 5 parts by weight of C.I. Pigment Yellow 180 were used instead of coloring agent-containing particles 1.

The obtained developing agent was tested and evaluated in the same manner as in Example 1. The results are shown in Table 1.

TABLE 1

| | Colorant- | Color | |
|---|---|---|---|
| | containing | development | |
| | particles | properties | Transparency |
| Example 1 | 1 | ◯ | ◯ |
| Example 2 | 2 | ◯ | ◯ |
| Example 3 | 3 | ◯ | ◯ |
| Example 4 | 4 | ◯ to ⊚ | ◯ to ⊚ |
| Example 5 | 5 | ◯ to ⊚ | ◯ to ⊚ |
| Example 6 | 6 | ◯ | ◯ |
| Example 7 | 7 | ◯ to ⊚ | ◯ to ⊚ |
| Example 8 | 8 | ◯ to ⊚ | ◯ to ⊚ |
| Comparative | — | ◯ | ◯ |
| example 1 | | | |
| Comparative | — | Δ | X |
| example 2 | | | |

As is apparent from Table 1 above, the developing agents of Examples 1 to 8 using the coloring agent-containing particles subjected to the mechanochemical processing were superior in both color development properties and transparency, similar to the developing agent of Comparative Example 1 using the masterbatch. In particular, the developing agents of Examples 4, 5, 7, and 8 having the third structure were excellent in color development properties and transparency. This is probably because the coloring agent particles used in Examples 2, 3, and 6 were further processed by metal oxide particles such as hydrophobic silica or titanium oxide, and this improved the dispersibility of the coloring agent particles to the binder resin.

In contrast, the developing agent of Comparative Example 2 using no coloring agent-containing particles were inferior in both color development properties and transparency.

In the above examples, only the results obtained for yellow toner are described. However, when magenta toner using Pigment Red 122 and cyan toner using Pigment Blue 15-3 were tested and evaluated in the same manner as for the yellow toner, similar results were obtained.

In the present invention as has been described above, effects equal to or superior to those obtained by the masterbatch method conventionally used to improve the color development properties and transparency can be obtained without using this masterbatch method. Since this eliminates the cost used for the masterbatch, toner can be provided at low cost.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A developing agent comprising
a binder resin, and
coloring agent-containing particles including a particulate coloring agent and a particulate additive treated with mechanochemical processing.

2. A developing agent according to claim 1, wherein said coloring agent-containing particle comprises a core of said coloring agent, and an additive covering layer which covers said core.

3. A developing agent according to claim 2, wherein said particulate additive comprises a particulate metal oxide.

4. A developing agent according to claim 1, wherein said coloring agent-containing particle comprises a core of said additive, and a coloring agent covering layer which covers said core.

5. A developing agent according to claim 4, wherein said additive comprises at least one material selected from the group consisting of fine crystalline polyester particles, wax particles, and metallic soap particles.

6. A developing agent according to claim 1, wherein said additive comprises first and second additives, and said coloring agent-containing particle comprises a core of said first additive, a coloring agent covering layer which covers said core, and a second additive covering layer which covers said coloring agent covering layer.

7. A developing agent according to claim 6, wherein said first additive comprises at least one material selected from the group consisting of fine crystalline polyester particles, wax particles, and metallic soap particles, and said second additive contains a particulate metal oxide.

8. A developing agent according to claim 1, wherein a mechanism used in said mechanochemical processing is one member selected from the group consisting of mechanofusion, hybridization, a cosmos system, and a mechano-mill.

9. An image forming apparatus comprising:
at least one image carrier;
a plurality of developing units which oppose said image carrier, contain developing agents having different colors, and form developing agent images of these different colors by developing electrostatic latent images formed in one-to-one correspondence with pieces of image information of the different colors on said image carrier;
a transfer unit which transfers the developing agent images onto a transfer medium; and
a fixing unit which fixes the developing agent images transferred onto the transfer medium,
wherein each of said developing agents contains a binder resin, and coloring agent-containing particles including a particulate coloring agent and a particulate additive treated with mechanochemical processing.

10. An apparatus according to claim 9, wherein said coloring agent-containing particle comprises a core of said coloring agent, and an additive covering layer which covers said core.

11. An apparatus according to claim 10, wherein said particulate additive comprises a particulate metal oxide.

12. An apparatus according to claim 9, wherein said coloring agent-containing particle comprises a core of said additive, and a coloring agent covering layer which covers said core.

13. An apparatus according to claim 12, wherein said additive comprises at least one material selected from the group consisting of fine crystalline polyester particles, wax particles, and metallic soap particles.

14. An apparatus according to claim 9, wherein said additive comprises first and second additives, and said coloring agent-containing particle comprises a core of said first additive, a coloring agent covering layer which covers said core, and a second additive covering layer which covers said coloring agent covering layer.

15. An apparatus according to claim 14, wherein said first additive comprises at least one material selected from the group consisting of fine crystalline polyester particles, wax particles, and metallic soap particles, and said second additive comprises a particulate metal oxide.

16. An apparatus according to claim 12, wherein a mechanism used in said mechanochemical processing is one member selected from the group consisting of mechanofusion, hybridization, a cosmos system, and a mechano-mill.
